(19) United States
(12) Patent Application Publication
(10) Pub. No.: US 2018/0336571 A1
(43) Pub. Date: Nov. 22, 2018

(54) DATA CUSTODIAN PORTAL FOR PUBLIC CLOUDS

(71) Applicant: SAP SE, Walldorf (DE)

(72) Inventors: Syed Wasif Ur Rehman Gilani, Cupertino, CA (US); Wesley Sularz, San Francisco, CA (US); Govind Lingam, Mountain View, CA (US); Andres Santanilla, San Francisco, CA (US)

(21) Appl. No.: 15/979,779

(22) Filed: May 15, 2018

Related U.S. Application Data
(60) Provisional application No. 62/506,756, filed on May 16, 2017.

(51) Int. Cl. G06Q 30/00; H04L 29/08; H04L 12/24

(52) U.S. Cl. CPC G06Q 30/018; H04L 41/22; H04L 67/10

(57) ABSTRACT

Methods, systems, and computer-readable storage media for providing a data custodian portal that communicates with a data custodian region within an infrastructure of a public cloud through a connector executed within the data custodian region, the data custodian region being specific to a customer of an enterprise having one or more computer-implemented services hosted on the public cloud, the infrastructure including a plurality of regional data centers, through which customer data passes and/or is stored, each data center being at a location within a region, in response to a determination that a data event associated with at least union fails to comply with a union definition of the at least one union, displaying a notification within a graphical user interface (GUI) of the data custodian portal, the union definition being used to control one or more of access, transfer, and storage of customer data within respective regional data centers, the union definition being provided by a data custodian associated with the customer, receiving, through the data custodian portal, first user input including a request for detail regarding the data event, in response to the first user input, providing the detail regarding the event, and receiving, through the data custodian portal, second user input including instructions for resolving the data event.

### CLAIM OF PRIORITY

This application claims priority under 35 USC § 119(e) to U.S. Provisional Patent Application Ser. No. 62/506,756, filed on May 16, 2017, the entire contents of which are hereby incorporated by reference.

### BACKGROUND

Enterprises use cloud-computing infrastructures to perform operations, the cloud-computing infrastructures hosting computer-executed services, data storage, data access, and the like. Example cloud-computing infrastructures include those provided by third-party cloud providers, each of which provides what can be generally referred to as a public cloud. Managing governance, risk, and compliance (GRC) can be a challenging exercise for an enterprise that has its services hosted in a public cloud. Additionally, the global footprint of public clouds significantly expands the scope of regional risk and compliance issues.

Public cloud service providers aim to comply with standards and regulations, but there is a need to provide greater transparency to be able to detect unexpected data access, and to ensure that data resides within the geographical boundaries as is required by customers. Besides transparency various controls are needed that can influence the access, movement, placement, and processing of data. Often the approach to satisfy enterprise concerns about GRC has been to use an isolated private cloud built and run either by the enterprise itself, or an independent regionally trusted third party, which monitors access, and safeguards data protection for enterprise customer data residing in public clouds. Such private clouds are considerably scaled-back and out-of-sync with respect to current public cloud service offerings.

### SUMMARY

Implementations of the present disclosure include computer-implemented methods for a data custodian portal for public clouds. In some implementations, actions include providing a data custodian portal that communicates with a data custodian region within an infrastructure of a public cloud through a connector executed within the data custodian region, the data custodian region being specific to a customer of an enterprise having one or more computer-implemented services hosted on the public cloud, the infrastructure including a plurality of regional data centers, through which customer data passes and/or is stored, each data center being at a location within a region, in response to a determination that a data event associated with at least union fails to comply with a union definition of the at least one union, displaying a notification within a graphical user interface (GUI) of the data custodian portal, the union definition being used to control one or more of access, transfer, and storage of customer data within respective regional data centers, the union definition being provided by a data custodian associated with the customer, receiving, through the data custodian portal, first user input including a request for detail regarding the data event, in response to the first user input, providing the detail regarding the event, and receiving, through the data custodian portal, second user input including instructions for resolving the data event. Other implementations of this aspect include corresponding systems, apparatus, and computer programs, configured to perform the actions of the methods, encoded on computer storage devices.

These and other implementations can each optionally include one or more of the following features: the data event is one of a data access event that fails to comply with the union definition, a data movement event that fails to comply with the union definition, and a data storage event that fails to comply with the union definition; the GUI displays a graphical representation of the data event as a map depicting one or more data centers of the at least one union; the data custodian portal provides one or more suggested actions for resolving the data event, the second user input at least partially including a selection of a suggested action of the one or more suggested actions. actions further include displaying, by the data custodian portal, a request to modify user access rights, the data event including a data access event associated with a user; actions further include displaying, by the data custodian portal, a refinement proposal to the request to modify user access rights, the refinement proposal including modification to user access of at least one other user in addition to the user; and the data event includes a data access event resulting from an agent of a public cloud provider of the public cloud.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIGS. 3A-3L depict example screenshots of a cloud security analyst portal in accordance with implementations of the present disclosure.

FIGS. 4A-4D depict example screenshots of an access management portal in accordance with implementations of the present disclosure.

FIGS. 5A-5F depict example screenshots of a report generation portal in accordance with implementations of the present disclosure.

FIG. 6 depicts an example process that can be executed in accordance with implementations of the present disclosure.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are generally directed to a data custodian portal of a data custodian platform for public clouds. More particularly, implementations of the present disclosure are directed to a data custodian platform of a data custodian platform that manages governance, risk, and compliance (GRC) for enterprises with services hosted in public clouds. As described in further detail herein, implementations of the present disclosure provide a data custodian portal that enables users (e.g., agents of a data custodian) to interact with a data custodian platform that provides independently configurable transparency, and controls to achieve the level of GRC for data access and data sovereignty that an enterprise customer requires. The data custodian portal of the present disclosure can be provided as part of a data custodian platform for public clouds, such as that described in detail in commonly assigned, U.S. Prov. App. No. [to be determined], filed on May 16, 2017, and entitled Data Custodian Model and Platform for Public Clouds, the disclosure of which is expressly incorporated herein by reference in the entirety for all purposes.

Implementations can include actions of providing a data custodian portal that communicates with a data custodian region within an infrastructure of a public cloud through a connector executed within the data custodian region, the data custodian region being specific to a customer of an enterprise having one or more computer-implemented services hosted on the public cloud, the infrastructure including a plurality of regional data centers, through which customer data passes and/or is stored, each data center being at a location within a region, in response to a determination that a data event associated with at least union fails to comply with a union definition of the at least one union, displaying a notification within a graphical user interface (GUI) of the data custodian portal, the union definition being used to control one or more of access, transfer, and storage of customer data within respective regional data centers, the union definition being provided by a data custodian associated with the customer, receiving, through the data custodian portal, first user input including a request for detail regarding the data event, in response to the first user input, providing the detail regarding the event, and receiving, through the data custodian portal, second user input including instructions for resolving the data event.

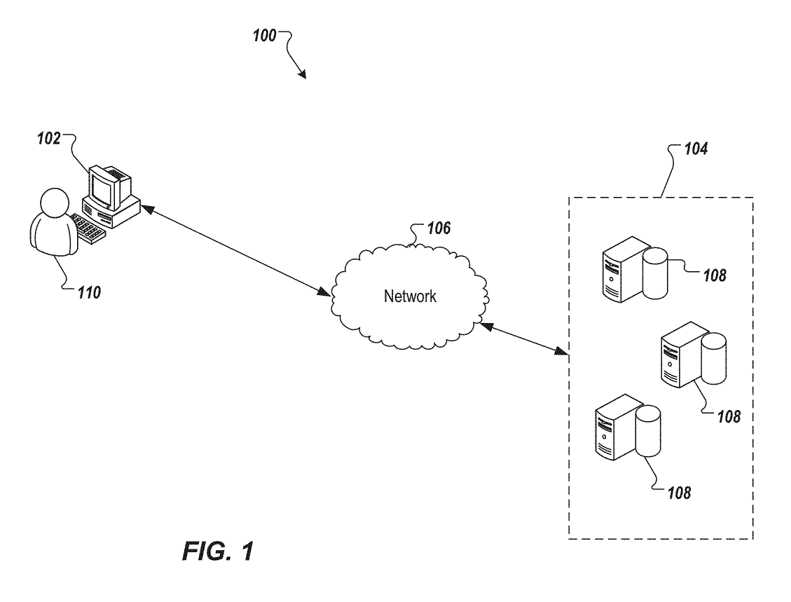

FIG. 1 depicts an example architecture 100 that can be used to execute implementations of the present disclosure. In the depicted example, the example architecture 100 includes one or more client devices 102, 104, a server system 106 and a network 108. The server system 106 includes one or more server devices 110. In the depicted example, a user 112 interacts with the client device 102, and a user 114 interacts with the client device 104. In an example context, the users 112, 114 can include users, who interact with one or more enterprise services that are hosted by the server system 106.

In some examples, the client devices 102, 104 can communicate with one or more of the server devices 108 over the network 106. In some examples, the client devices 102, 104 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 108 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 110 includes at least one server and at least one data store. In the example of FIG. 1, the server devices 110 are intended to represent various forms of servers including, but not limited to a web server, an application server, a proxy server, a network server, and/or a server pool. In general, server systems accept requests for application services and provides such services to any number of client devices (e.g., the client devices 102, 104) over the network 108.

In accordance with implementations of the present disclosure, the server system 106 can provide a public cloud infrastructure. More particularly, the server system 106 can provide a cloud-computing infrastructure that can host computer-executed services offered by one or more enterprises to their customers. In the context of the present disclosure, the cloud-computing infrastructure can be a public cloud that is provided by a third-party cloud provider. Example third-party cloud providers include Amazon.com, Inc., which provides the Amazon Web Services (AWS) cloud-computing platform, Google, Inc., a subsidiary of Alphabet, Inc., which provides the Google Cloud Platform, and Microsoft, Inc., which provides the Azure cloud-computing platform.

Although a single server system 106 is depicted, it is contemplated that multiple server systems 106, each provided by a respective third-party cloud provider, can be provided. For example, an enterprise can have its services hosted on a public cloud, or multiple public clouds.

In accordance with implementations of the present disclosure, the user 112 can be an agent (e.g., administrator, developer) of an enterprise that has computer-executed services hosted on one or more public clouds (e.g., a public cloud provided by the server system 106). The user 114 can be an agent (e.g., security analyst, risk compliance officer (RCO) of a customer of the enterprise, which customer uses the computer-executed services hosted on one or more public clouds.

To provide further context for implementations of the present disclosure, migration to the cloud is inevitable once an enterprise realizes the significant benefit of using a public cloud. Many of the available top-tier public clouds are enterprise-ready, and application rich with both Infrastructure-as-a-Service (IaaS), and Platform-as-a-Service (PaaS) offerings. However, when an enterprise decides to move its applications to the public cloud, it loses physical access to the infrastructure hosting its information and customer data. A key concern of enterprises is to retain complete control and transparency of how their sensitive data is accessed, handled, and processed on public cloud platforms, while at the same time benefiting from the agility, scale and global presence of a public cloud platform. The impact that an unauthorized access can have is considerable, given their level of access and ability to infiltrate enterprises and assets. Brand damage, financial impact, and productivity losses are just some of the ways a malicious access can affect an operation. The enterprise must find a way to establish the trust that is necessary to ease the concerns of their customers, and ensure that proper GRC procedures are being followed at all times (e.g., they have not been preempted by a recent system update).

Public cloud compliance with industry standards and regulations are posted by auditors for all potential customers. To increase the level of trust above and beyond simple compliance, enterprise customers need solutions that increase transparency and control sufficient to demonstrate to internal and external stakeholders that data has been handled and accessed in accordance to policies. One way to satisfy enterprise concerns around data handling is by isolation. Isolation could be accomplished by building a private cloud that can be run either by the enterprise or an independent, regionally trusted third party. Such private clouds, however, tend to be considerably scaled back versions of full public cloud service offerings. One strength of a public cloud is the resiliency made possible by replication and migration across zones and regions to ensure high availability. The idea of isolation to gain trust comes at the cost of global presence, and high availability. Accordingly, a goal for developing a public cloud solution for enabling GRC management must include preserving, as much as possible, the full strength of the global public cloud features. Going beyond transparency, additional measures of GRC control are needed so that an enterprise is able to influence the systematic movement, placement, and execution of computation and data.

In view of this, and as introduced above, implementations of the present disclosure provide a data custodian portal for interacting with a data custodian platform based on a data custodian model (DCM). In some implementations, the DCM addresses the core needs of data sovereignty compliance, data transparency and control for enterprise customers, while preserving the collective global strength of public clouds. The DCM provides independent visibility and control to configure the level of GRC for data access and sovereignty to meet each enterprise customer requirements. This is a step towards empowering enterprise customers with complete visibility and control over their data storage location, data movement and data processing locations, and access to their sensitive data within one or more public clouds.

In some implementations, a third-party public cloud provider offers the DCM features in all regions (e.g., globally), and continues to design-build-run datacenters as its primary role. A data custodian (e.g., a customer of an enterprise) is provided access to a customer log repository (CLR), which contains audit logs revealing all types of accesses made to the customer data (e.g., human accesses made from the customer side and/or the public cloud provider side, machine accesses). In some examples, customers grant third-parties (e.g., a third-party data custodian) access to their logs so that the data custodian is able to review and analyze these logs on the customer's behalf. The public cloud provider exposes an application program interface (API) for access to the CLR on behalf of the customer.

As described in further detail herein, the data custodian-based solution of the present disclosure enables producing GRC access transparency reports, running continuous GRC risk analysis, and activating GRC controls for public cloud services. Further, a number of templates can be provided for commonly requested definitions, reports, and analytics.

In some implementations, the data custodian accesses a separate data custodian zone (DCZ) within a public cloud provider region to support trusted data custodian functions. An example trusted function includes (third-party) encryption key management (EKM). In some implementations, all public cloud provider regions that want to offer data custodian functionality must specifically support DCZs within their selected regions.

In the DCM of the present disclosure, customers always own their data and access to their data. The pubic cloud provider provides all of the physical and logical (digital) security capabilities, and procedures for policy enforcement. These capabilities can be configured as data custodian controls by the customer with or without the help of a trusted third-party acting as the data custodian. An example tenet of the DCM is verification that requires transparency of the mechanisms, and processes to be able to distinguish between normal and abnormal workflows. The data custodian does the task of processing all types of access logs including audit logs, which capture all types of accesses, human and machine, made to the customer data. Additionally, the data custodian is provided with specialized, insider access logs by the public cloud provider that capture all types of accesses made from the public cloud provider side to the customer data, and customer infrastructure (for example, admin accesses, support team accesses, etc.) for various reason including support activities. The data custodian is responsible for handling and processing large amounts of transparency information (e.g., logs, statistics, etc.), and, for example, developing machine-learning pattern recognition to detect and report all type of accesses and anomalies happening to the customer data.

As described in further detail herein, there are multiple data custodian controls that require active data custodian operational involvement. Examples of this include providing trusted third-party key-encrypting-key (KEK) support, and providing private computing.

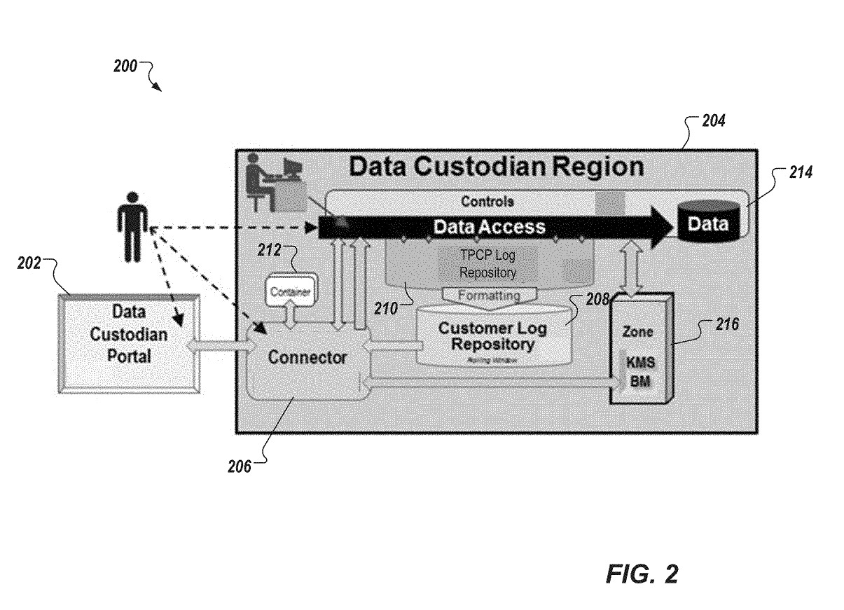

FIG. 2 depicts an example conceptual architecture 200 in accordance with implementations of the present disclosure. The example conceptual architecture is described in detail in U.S. Prov. App. No. [to be determined] referenced above.

The example conceptual architecture 200 of FIG. 2 can be referred to as a data custodian architecture. In the depicted example, the example conceptual architecture 200 includes a data custodian portal 202, and a data custodian region 204. In some examples, the data custodian region 204 is provided as at least a portion of a public cloud that is assigned to a data custodian (e.g., enterprise), and within which the data custodian can implement union-based controls, described in further detail herein.

In some implementations, the conceptual architecture 200 of FIG. 2 is based on services. In some examples, the public cloud provider infrastructure and application services are billed by the public cloud provider at a contracted rate with the customer (and/or enterprise).

In the depicted example, the data custodian region 204 includes a connector 206 that supports both transparency and control aspects of the DCM. In some examples, the connector 206 is provided as a licensed software package. In some examples, the customer pays for resources consumed by the connector 206. In some examples, although the connector 206 supports a basic command line interface, the connector 206 also supports an API for the DCP 202 (e.g., on the data custodian side).

In some examples, the DCP 202 is a data custodian provided, value added service that would have costs associated with it depending on how it is bundled with other data custodian support services (e.g., Max Attention, One Support). The DCP 202 may also include integration with other application level GRC support for enterprise applications, which is already available (e.g., SAP GRC provided by SAP SE of Walldorf, Germany). The DCP 202 may include a notification function which would also have additional costs associated with notification delivery and remediation. The nature of some reports might also have premium costs associated with them. For example, if the data custodian is producing a report that is subject to reference in litigation, it might require the data custodian to certify the correctness and timing. The costs for services provided through the DCP 202 can vary depending on how the data custodian delivers the service, and the scope of the services used.

In the depicted example, the data custodian region 204 includes a CLR 208. The CLR 208 has costs that are volume and activity related as more active customer landscapes will generate more log entries requiring more processing overhead in the cloud infrastructure. In some examples, the CLR 208 is a time sequence cache for logs and costs would be related to the cache depth size selected. In some examples, the data custodian region 204 provides private computing as a managed service offered by the data custodian, and would have a separate billing arrangement with the data custodian.

The conceptual architecture of FIG. 2 further includes a log repository 210 of the third-party cloud provider, one or more containers 212, union-based controls 214, and a zone 216. In some implementations, the log repository 210 records all data-related events described herein (e.g., access, movement, processing), and provides log data to the CLR 208. In some implementations, a container 212 can be provided to support processing of event data. For example, a data analytics application can be hosted in a container 212 to provide real-time analysis of event data. In some examples, and as described in further detail herein, the zone 216 enables third-party KMS, and/or private computing on the public cloud. The zone 216 can be described as a separate data custodian secured area in the data center(s) of the public cloud, and is separate from access and influence by the public cloud provider. In accordance with implementations of the present disclosure, the controls 214 are union-based controls, which enable a data custodian to define availability of respective functions across regional data centers of the public cloud. Union-based controls are described in further detail herein.

As described in detail in U.S. Prov. App. No. [to be determined] referenced above, the data custodian platform provides union-based controls for regulating data-related functions for customer data within public clouds. A union can be described as an associated set of physical data centers. If geography were the only association attribute of a union, it would result in unions of data centers being defined based on geographic location (e.g., Global union including all data centers; Americas union including only data centers located in North, Central, and South Americas; Asia union including all data centers located in Asian countries). However, the union association attributes provided by the DCM are much more granular, and account for data access within various public cloud provider workflows. These attributes enable customers to define unions according to their business and/or compliance needs. For example, the DCM enables customers to have multiple union definitions active (e.g., one for each different service offering), and to formalize data movement between unions.

In some implementations, one or more union definitions can be provided, each union definition associating one or more functions with one or more data center locations, and/or regions. Example functions include data placement (e.g., where (encrypted) data can be stored), data movement (e.g., data centers through which (encrypted) data can pass), data key-management (e.g., data centers, at which encryption keys can be managed), data processing (e.g., data centers, at which (unencrypted) data can be processed), user access (e.g., data centers having data that users can access), and private computing (e.g., data centers that can perform private computing). Accordingly, each union definition provides location-based (data center locations) control of functions that can be performed at respective data centers of the public cloud.

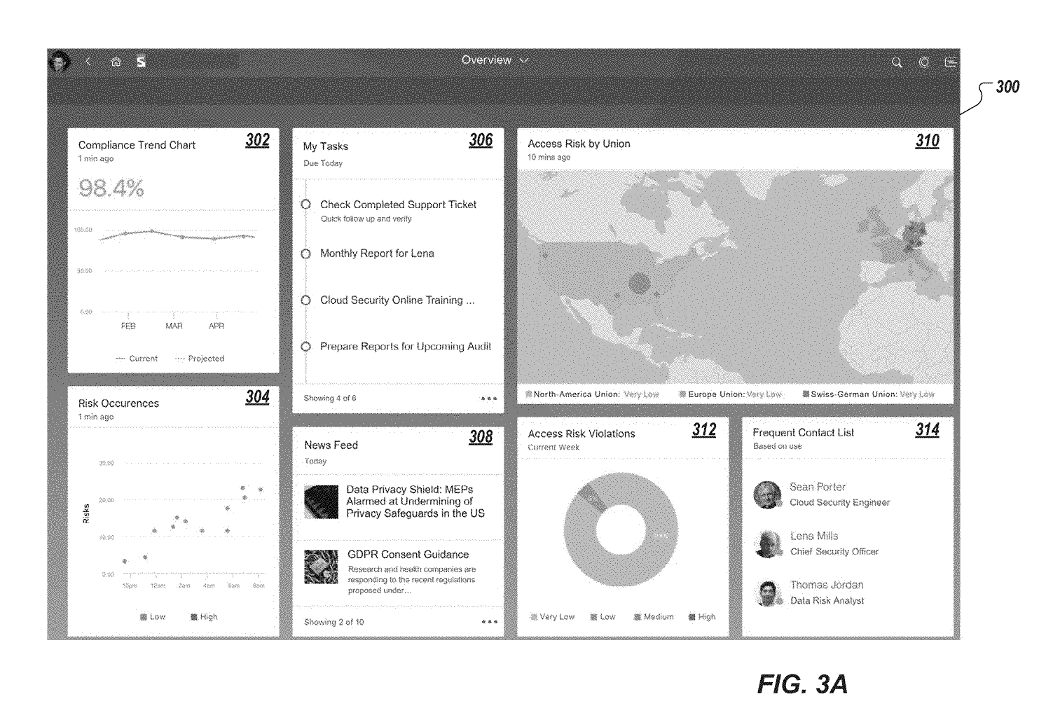

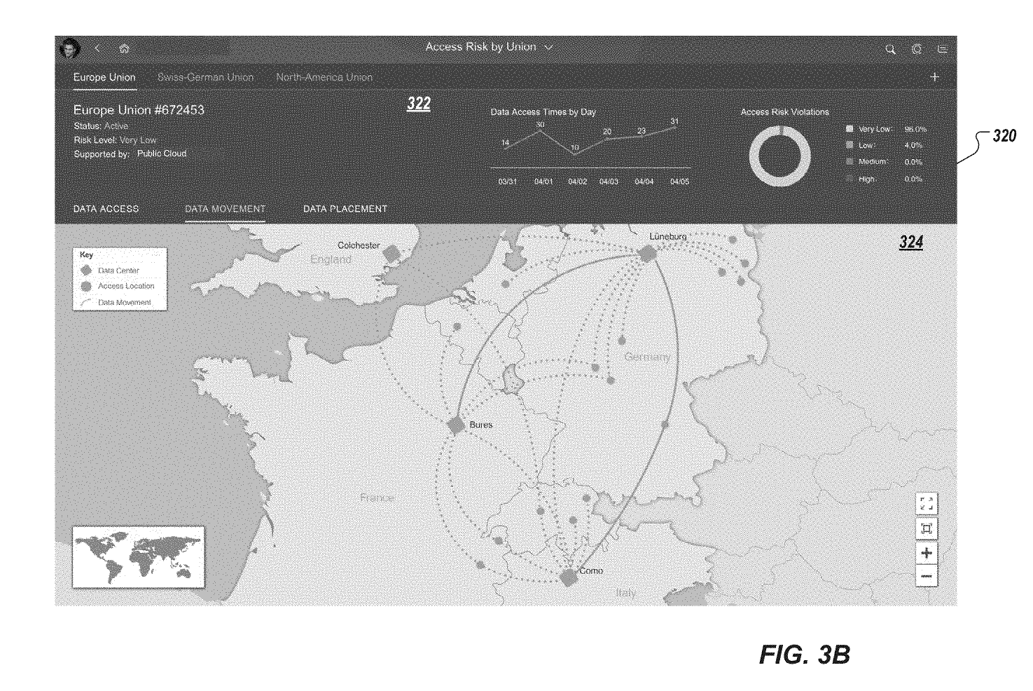

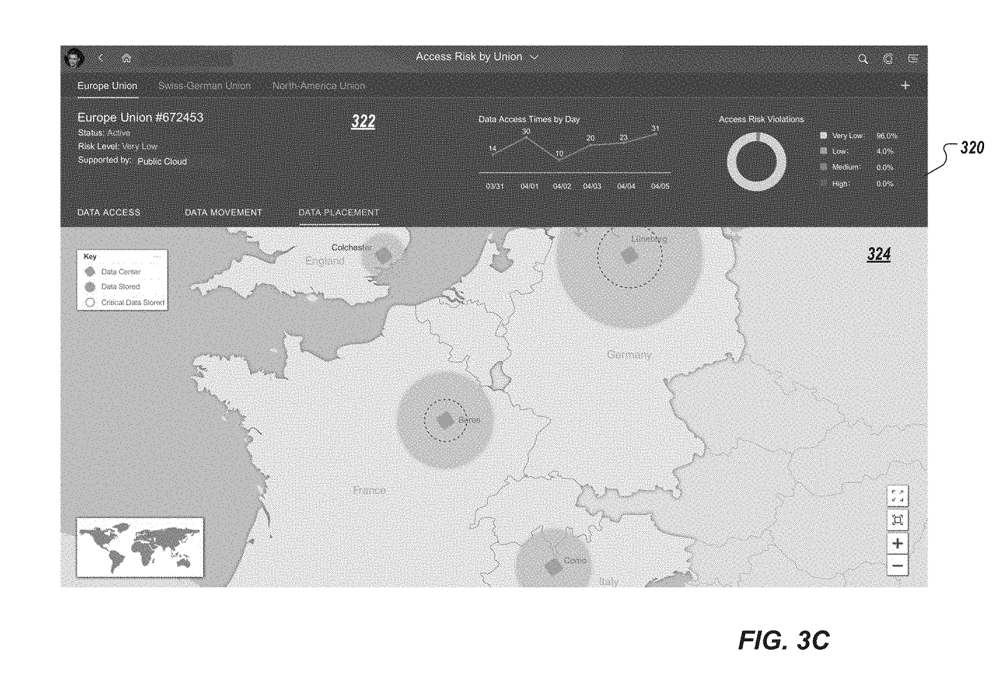

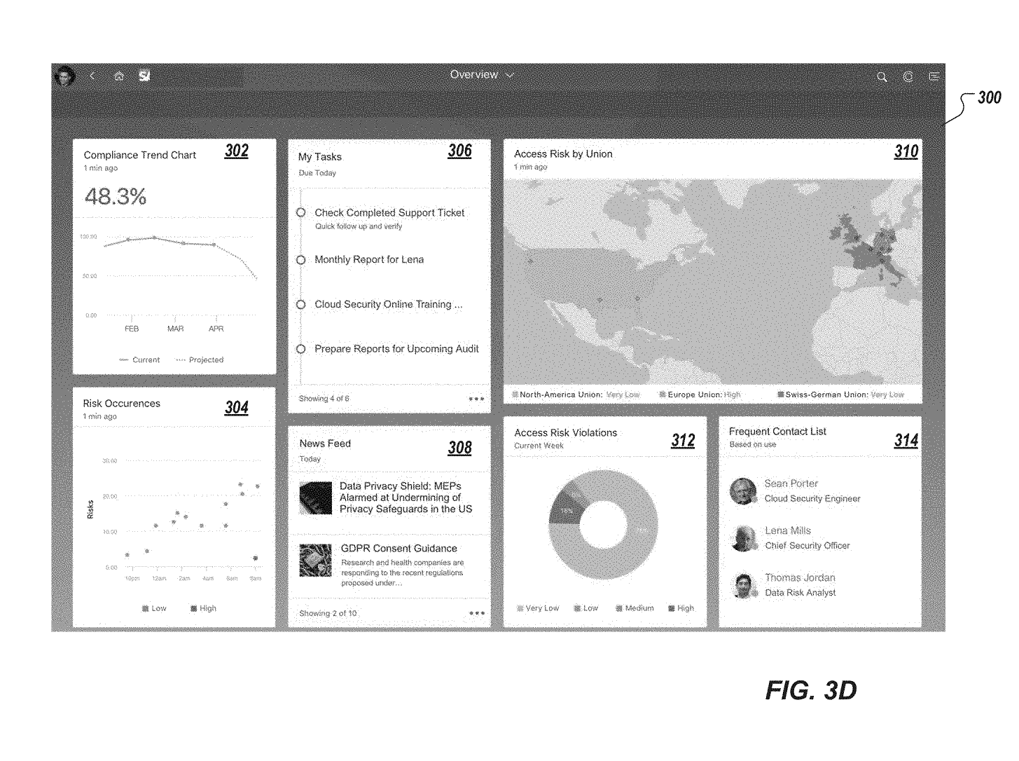

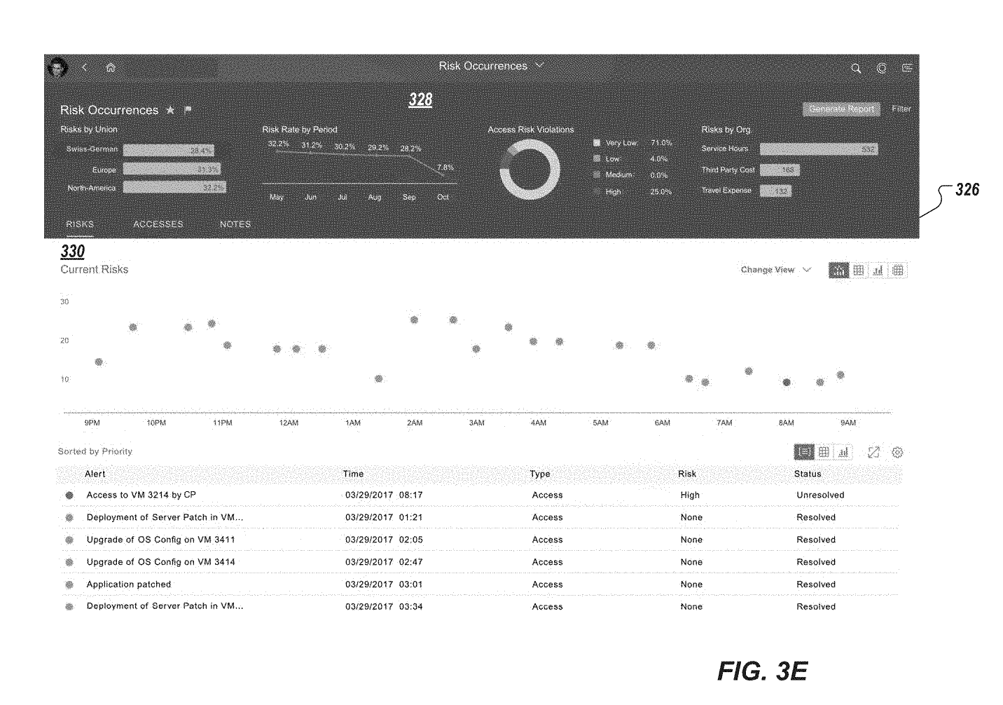

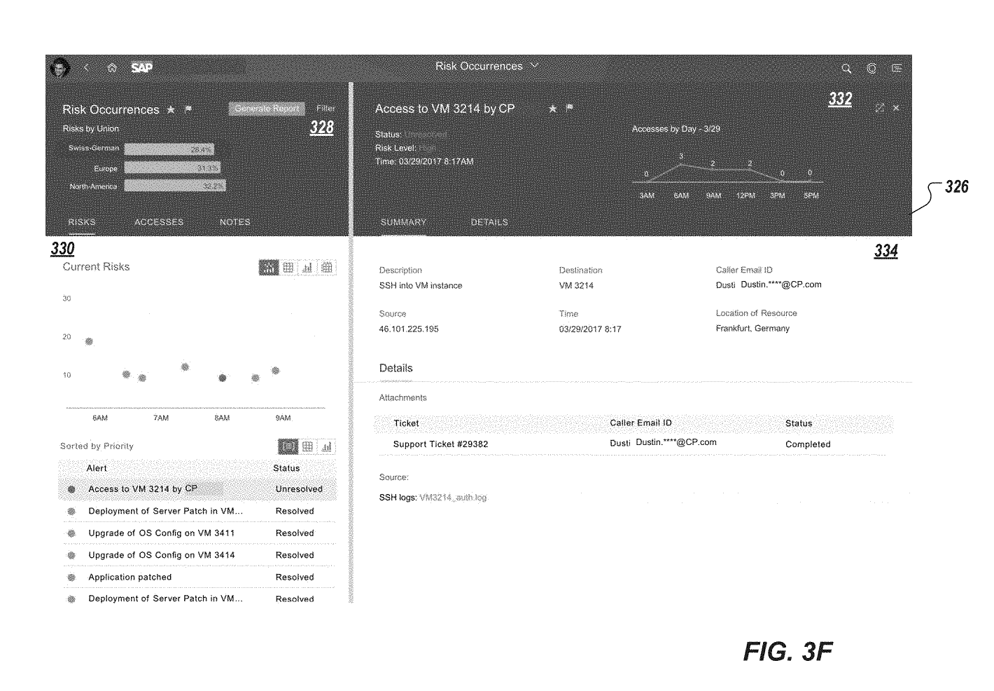

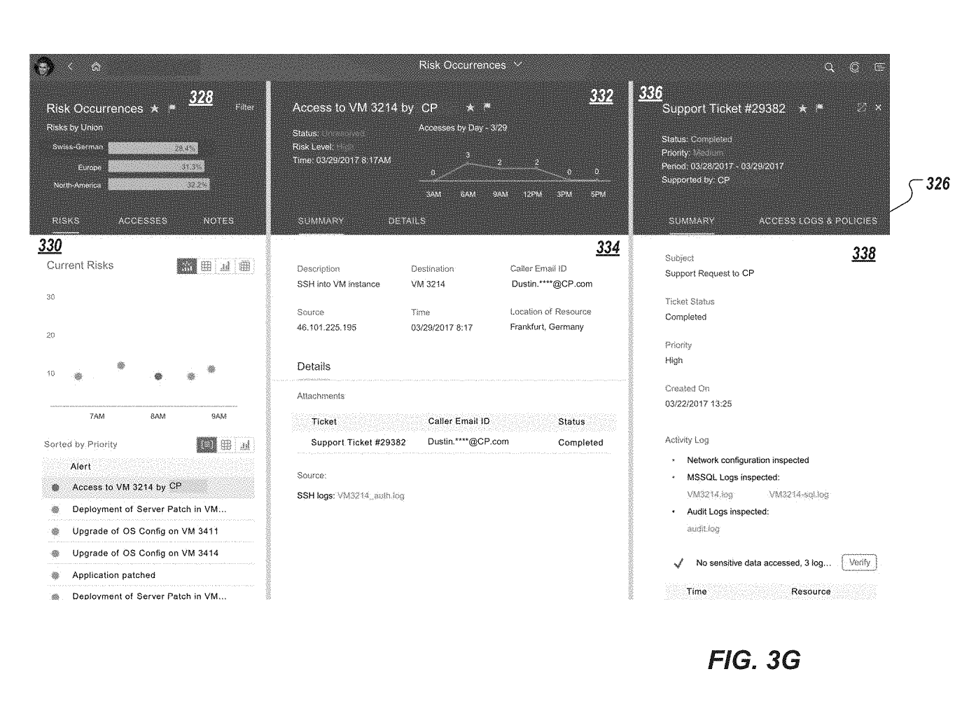

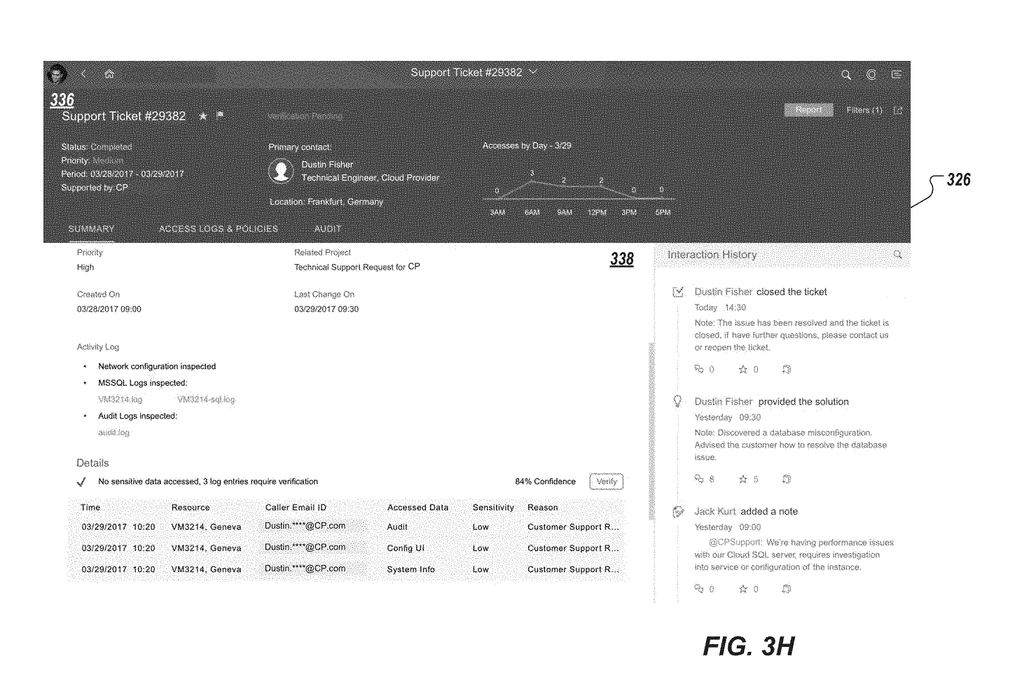

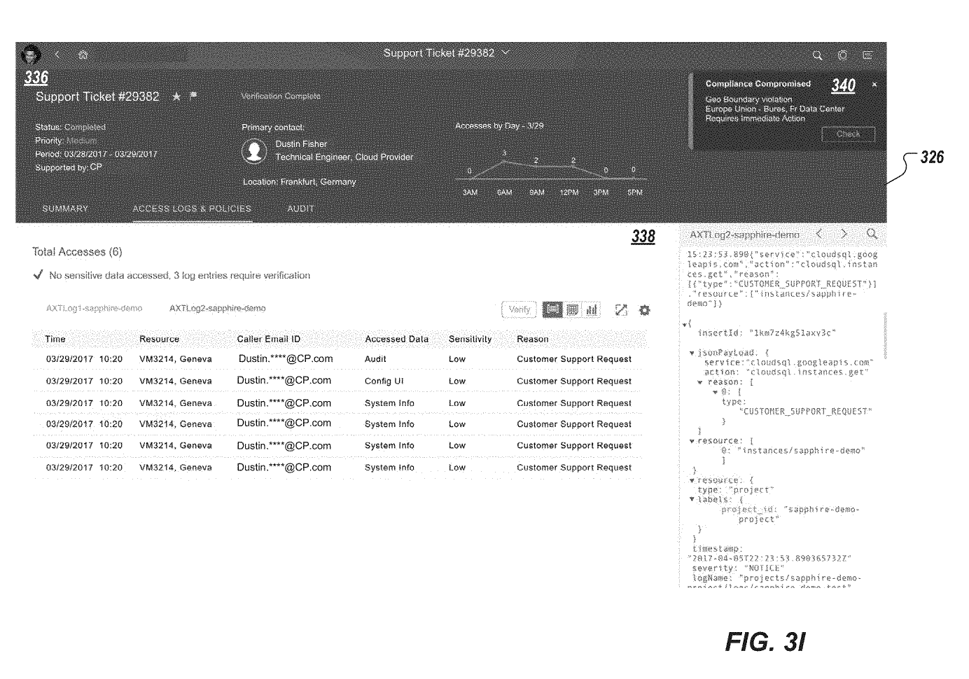

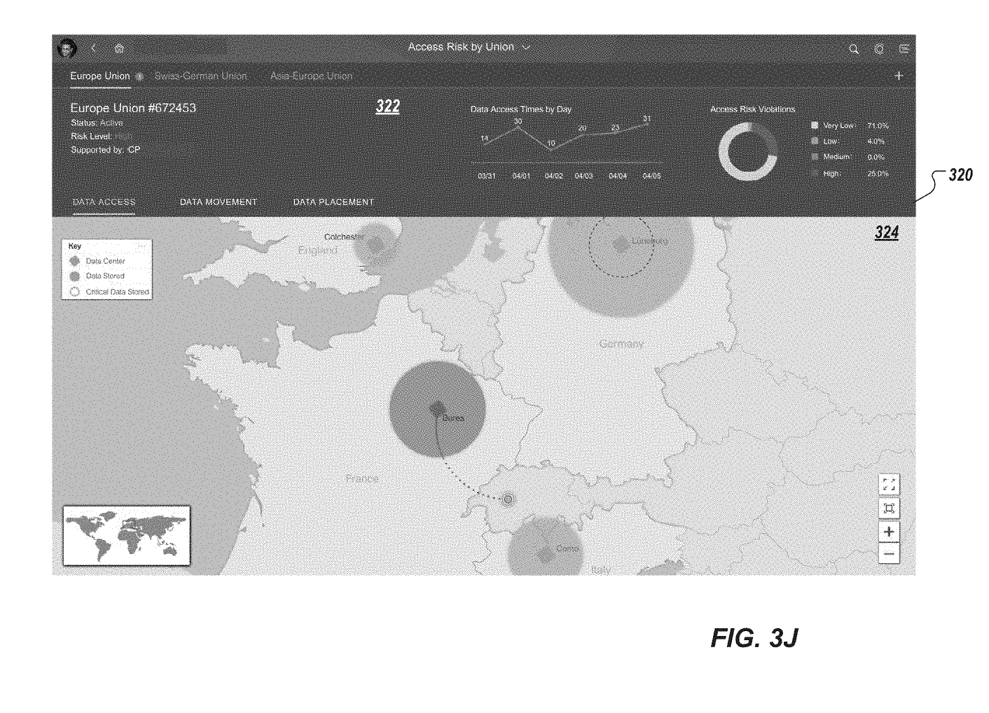

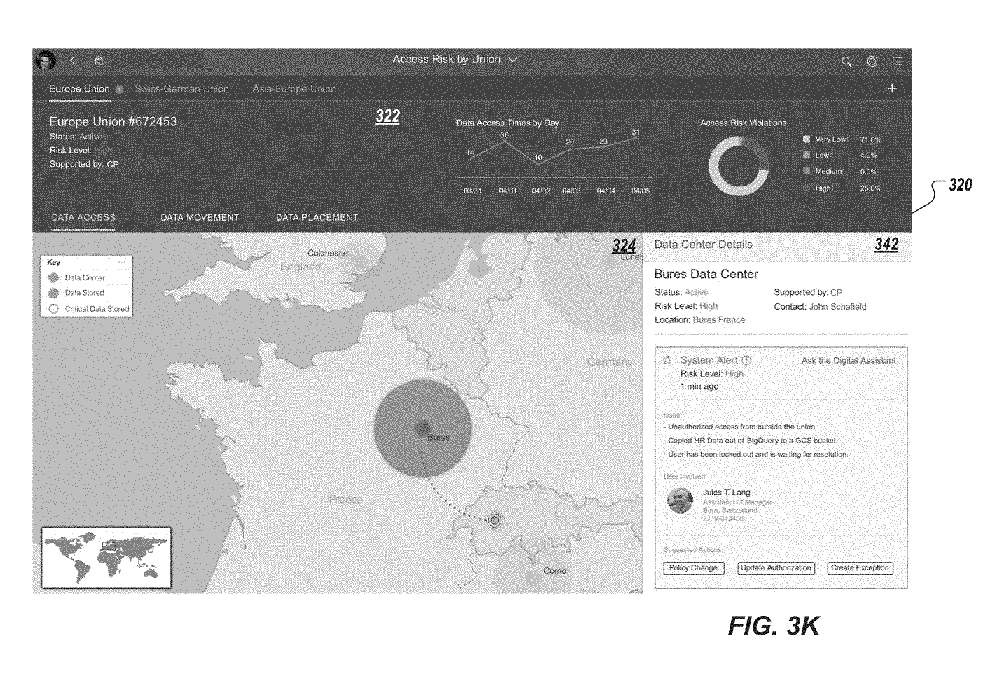

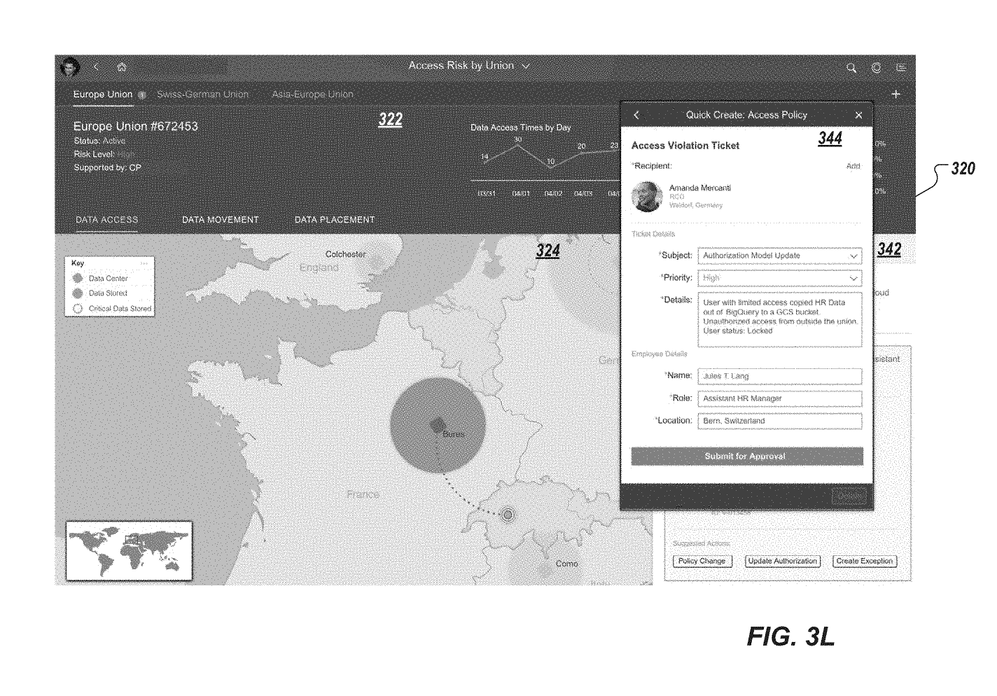

FIGS. 3A-3L depict example screenshots of a cloud security analyst portal in accordance with implementations of the present disclosure. In some examples, the example screenshots of FIGS. 3A-3L are based on data events within a public cloud provided by a public cloud provider. A fictitious public cloud provider is referred to herein as Cloud Provider (CP), which provides a fictitious public cloud platform, Public Cloud. The examples of FIGS. 3A-3L are based on an example narrative, in which a customer (data custodian) is an international, EU-based company that has recently acquired another company. The acquisition has resulted in changes to deployment and access policies, and a transition period has been implemented to more closely monitor risks that may affect their business. The narrative references multiple roles of the company, which include a cloud security analyst, a risk compliance office (RCO), and a chief risk officer (CRO).

FIG. 3A depicts an example overview graphical user interface (GUI) 300 for a cloud security analyst. In the example of FIG. 3A, the GUI 300 includes a compliance trend UI 302, a risk occurrences UI 304, a tasks UI 306, a news feed UI 308, an access risk by union UI 310, an access risk violations UI 312, and a contact list UI 314. In some examples, UIs (e.g., 302, 304, 310, 312) provide respective summaries and/or statistics related to customer data in view of function controls defined through one or more unions. Example unions include a North-America Union, a Europe Union, and a Swiss-German Union (e.g., as textually and graphically depicted in the access risk by union UI 310. In some examples, the UIs of FIG. 3A provide information corresponding to data access control, as defined in the respective unions. The example of FIG. 3A indicates low risk and good compliance across all unions.

FIG. 3B depicts an example access risk by union GUI 320. In some examples, the access risk by union GUI 320 is displayed in response to user selection of the access risk by union UI 310 of FIG. 3A. In the depicted example, the access risk by union GUI 320 includes a summary section 322, and a map section 324. The summary section 322 summarizes data information, and the map section 324 visually depicts data information. In the example of FIG. 3B, the access risk by union GUI 320 displays data related to the Europe Union. The map section 324 visually depicts data movement data (e.g., data indicating movement of data between data centers and/or access locations), but other parameters (e.g., data access, data placement) can be selected. For example, and as seen in FIG. 3C, in response to user selection of “Data Placement,” the map section 324 visually depicts data placement data (e.g., data indicating locations of stored, encrypted data).

FIG. 3D depicts the example overview GUI 300 in response to a high-risk violation, which causes the compliance trend to trend negatively. In response, the cloud security analyst can select one or more of the UIs (e.g., 302, 304, 310, 312) to investigate further.

FIG. 3E depicts an example risk occurrences GUI 326 that is displayed in response to user selection of the risk occurrences UI 304 of FIG. 3D. The example risk occurrences GUI 326 includes a risk occurrences summary section 328, and a current risks section 330. In general, the example risk occurrences GUI 326 graphically depicts data access patterns, and can be used to isolate the high risk access.

FIG. 3F depicts the example risk occurrences GUI 326 in response to user selection of an alert (e.g., the red alert, Access to VM 3214 by CP) from the current risks section 330. In the example of FIG. 3F, the example risk occurrences GUI 326 is modified to provide an alert overview section 332, and an alert information section 334. The example risk occurrences GUI 326 the source, the destination, and their locations, as well as the number of accesses made to the resources. In the depicted example, it is seen that the access by the CP resulted from a support request issued by the customer, which resulted in a support ticket (e.g., Support Ticket #29382). The support ticket can be selected to provide further detail.

FIG. 3G depicts the example risk occurrences GUI 326 in response to user selection of a support ticket (e.g., Support Ticket #29382) from the alert information section 334. In the example of FIG. 3G, the example risk occurrences GUI 326 is modified to provide a support ticket overview section 332, and a support ticket information section 334. In this example, it is shown that the support ticket resolution did not include access to sensitive data (e.g., No sensitive data accessed).

FIG. 3H depicts an expanded view of the support ticket overview section 332, and a support ticket information section 334 of the example risk occurrences GUI 326. In the depicted example, the support ticket information section 334 indicates that three log entries need to be verified. To look deeper into the situation, the user can select the Access Logs & Policies tab of the support ticket information section 334.

FIG. 3I depicts the expanded view of the support ticket overview section 332, and a support ticket information section 334 of the example risk occurrences GUI 326 in response to user selection of the Access Logs & Policies tab. The user (cloud security analyst) can review the information provided to determine that everything is in order, and that the issue is of low sensitivity. In response, the user can verify (e.g., by clicking on the Verify button) each of the log entries to resolve the issue.

In the example of FIG. 3I, a notification 340 pops-up in response to a compliance issue that has occurred. The user can select (e.g., click on) the notification 340 to begin addressing the compliance issue.

In response to user selection of the notification 340, the example access risk by union GUI 320 is displayed, as seen in FIG. 3J. In the depicted example, the access risk by union GUI 320 indicates a data access violation in the Europe union in the summary section 322, and the map section 324 indicates the location of the data access attempt from outside of the Europe Union (e.g., Bern, Switzerland), and the location of the data center that stores the requested data (e.g., Bures, France).

FIG. 3K depicts an expanded view of the access risk by union GUI 320 to include a data center details section 342. In the depicted example, the issue is described as an unauthorized access from outside of the Europe Union, which included human resources (HR) data being copied, and the user has been locked out. In some examples, an artificial intelligence (AI)-based digital assistant can recommend one or more actions to resolve the issue. In the depicted example, the recommended actions include a policy change, an authorization update, and an exception creation.

FIG. 3L depicts an expanded view of the access risk by union GUI 320 to include a pre-filled authorization update request 344. After confirming that the details of the update request are accurate, the user can submit the request for approval (e.g., by selecting the Submit for Approval button).

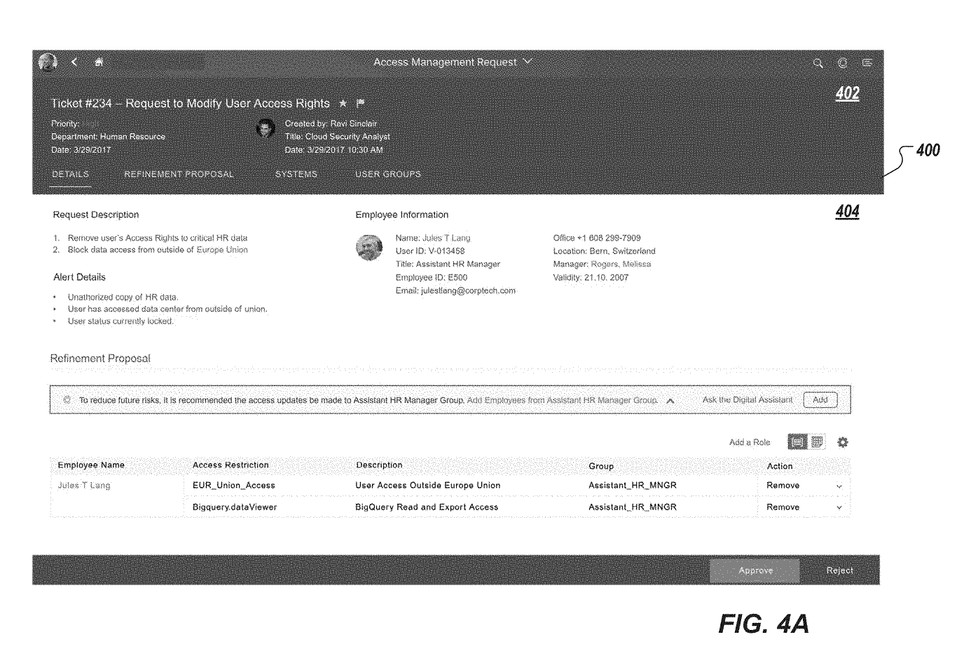

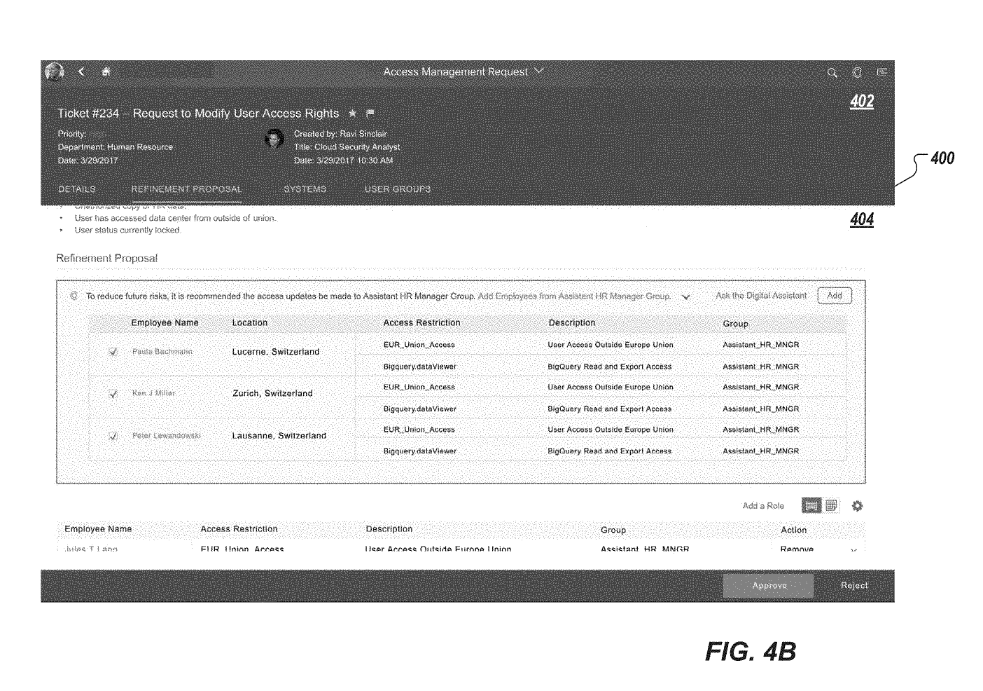

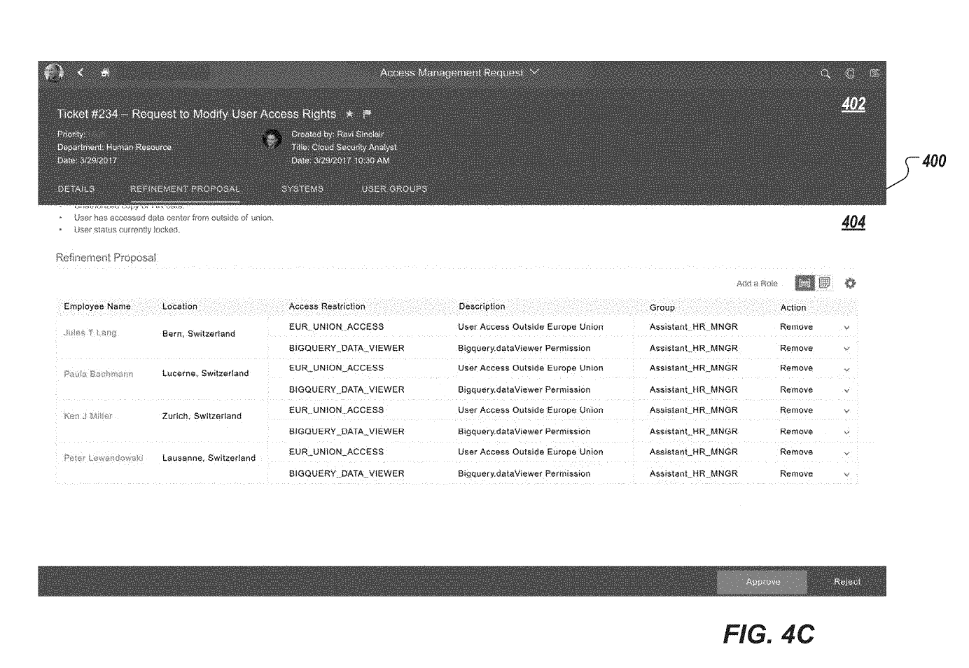

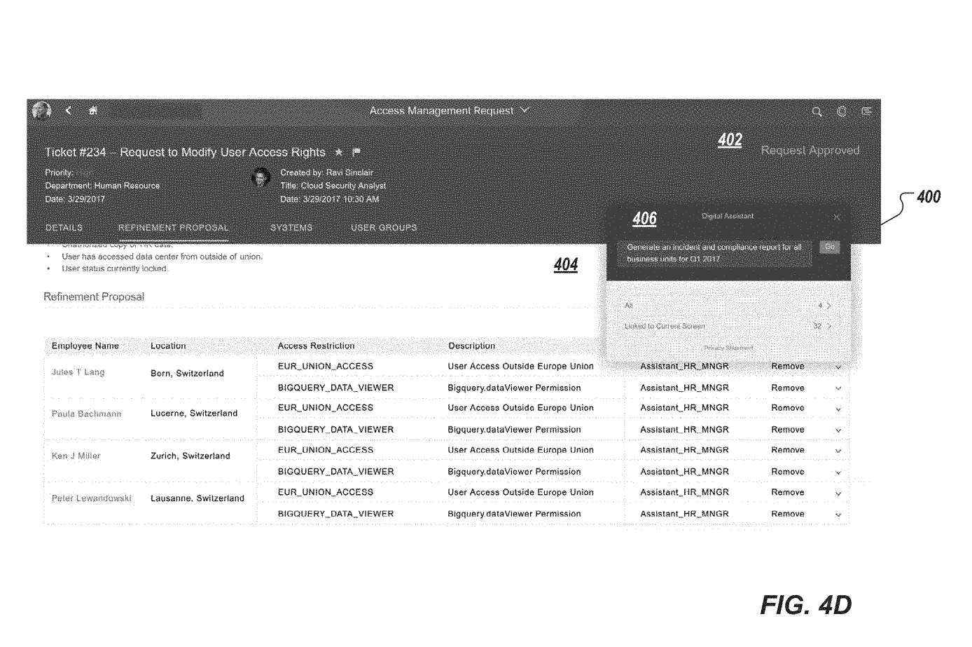

FIGS. 4A-4D depict example screenshots of an access management portal in accordance with implementations of the present disclosure. In FIG. 4A, an example access management GUI 400 is depicted. In some examples, the example access management GUI 400 is displayed to a RCO in response to submission of an authorization update request, such as that described above with reference to FIG. 3L. The example access management GUI 400 includes a request summary section 402, and a request detail section 404. In some examples, the RCO can review the request information, and determine that the user (Jules T. Lang) is an employee of the recently acquired company, who should be granted data access. In the depicted example, recommendations also include removing the user's access rights to critical HR data, and blocking data access from outside of the Europe Union. Further, a refinement proposal is provided, which, in the depicted example, includes making the same access updates to other users in the Assistant HR Manager Group.

FIG. 4B depicts an expanded refinement proposal of within the request detail section 404, which can be displayed in response to user selection of the refinement proposal. If the RCO determines that the refinement proposal is to be implemented, the RCO can select the Add button. FIG. 4C depicts the request detail section in response to the RCE selecting to add the other users per the refinement proposal. The RCO can approve the access updates by selecting the Approve button, and, in response, a Request Approved message can be displayed.

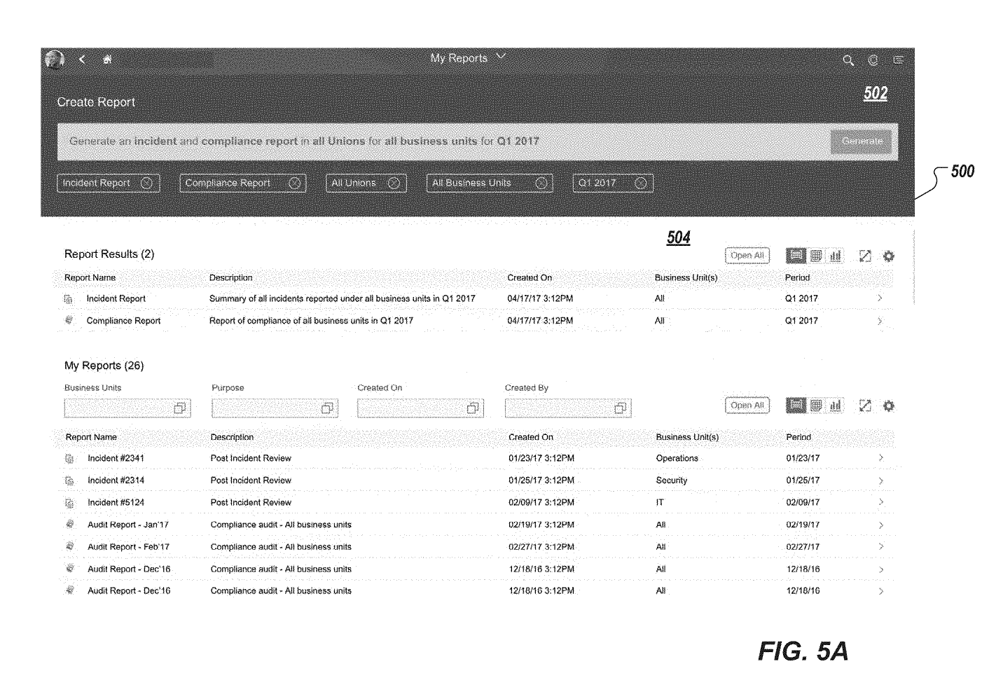

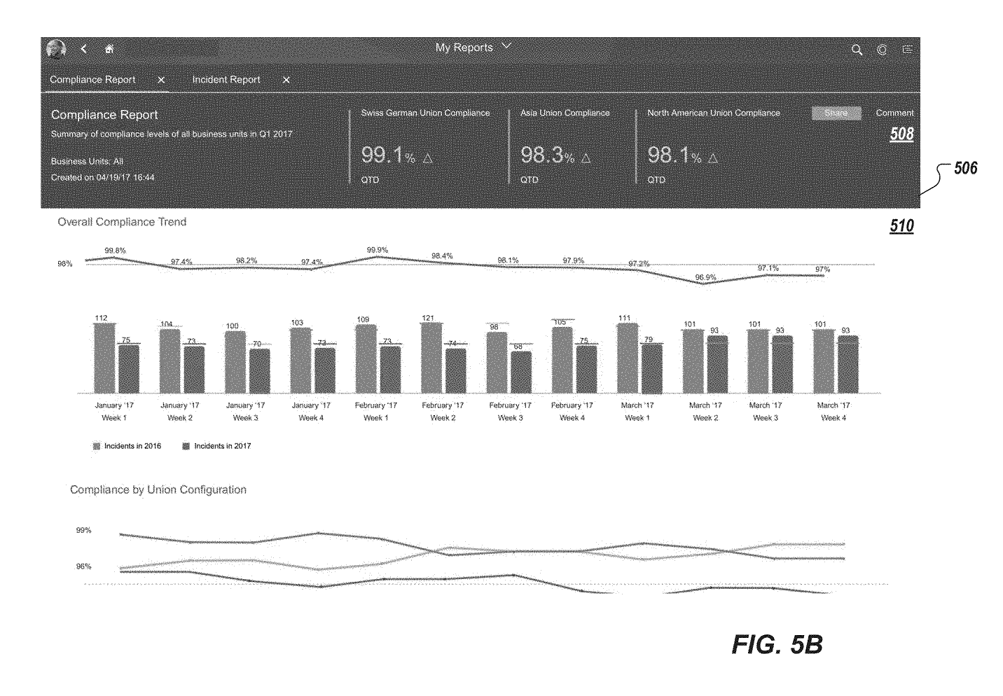

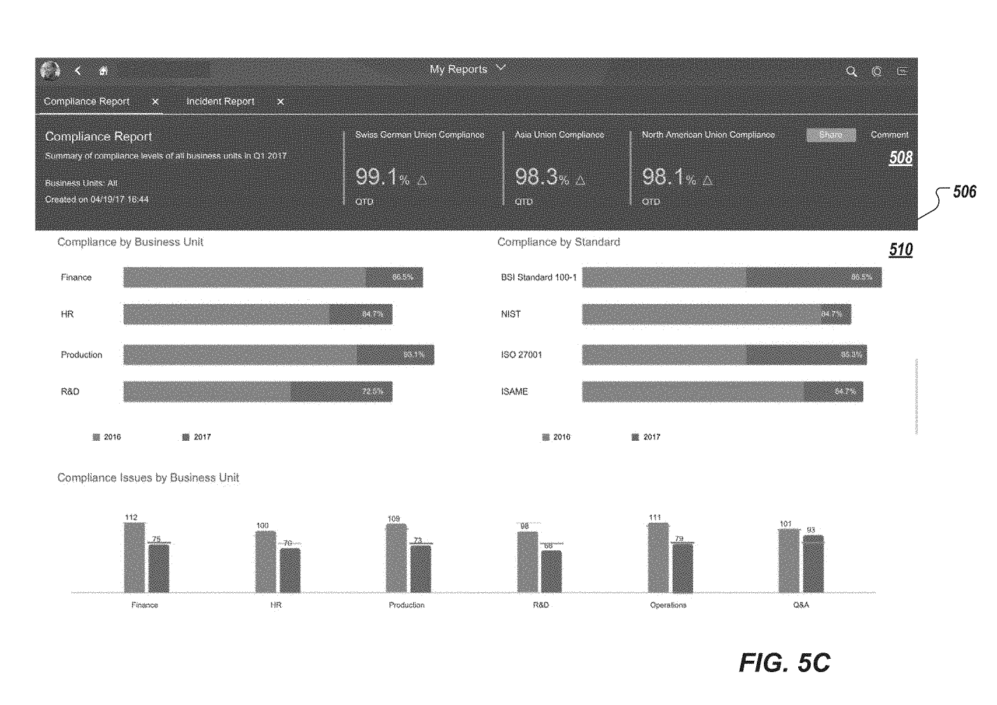

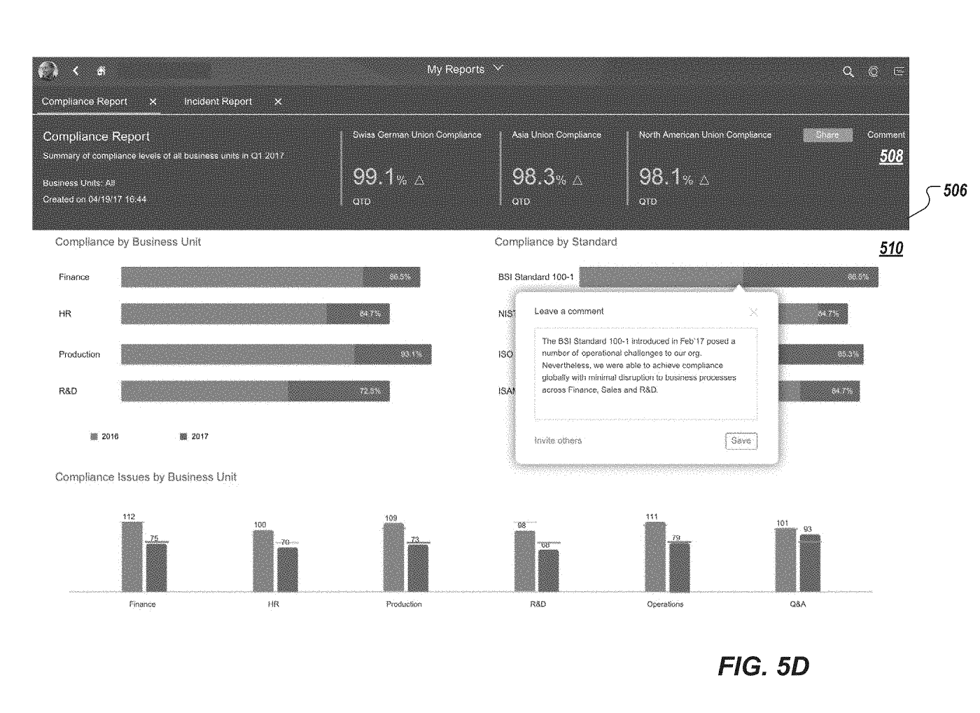

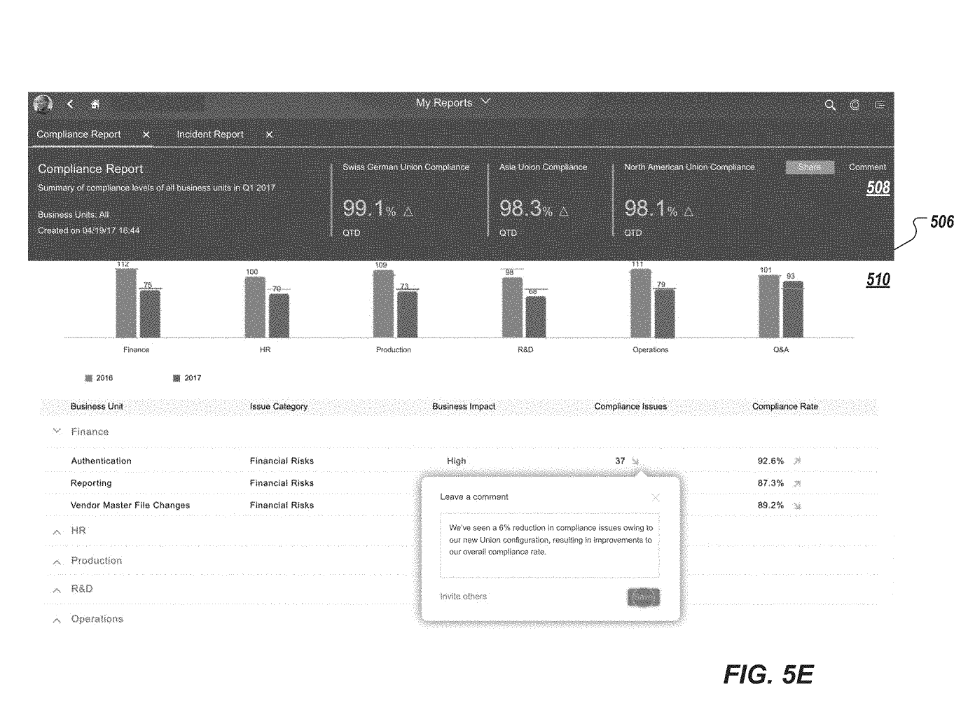

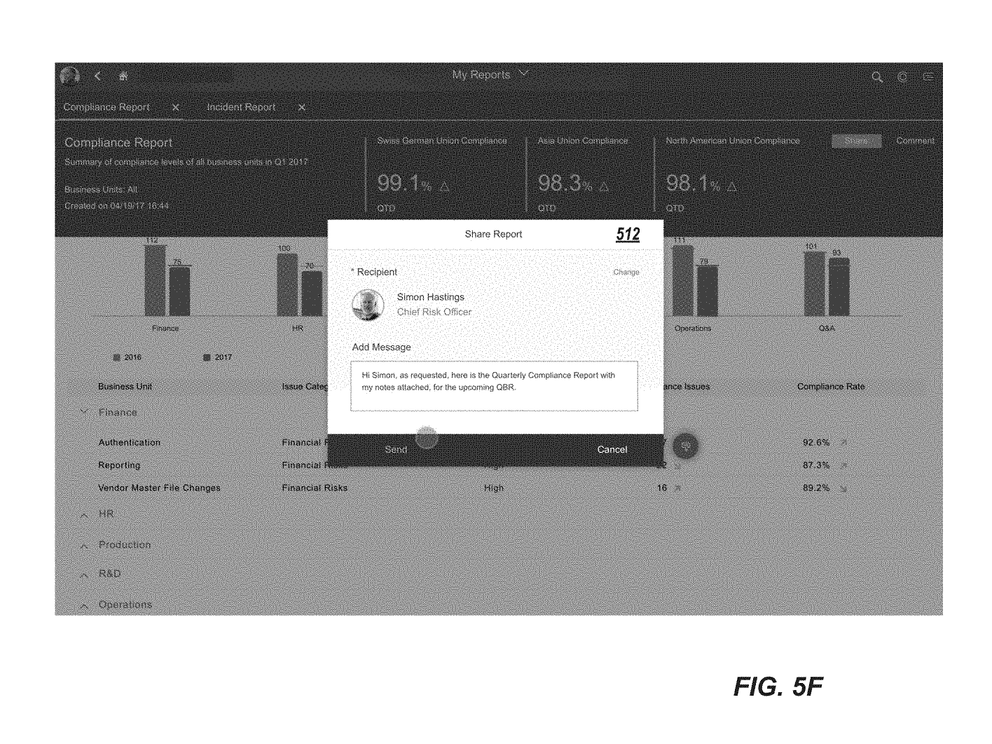

FIGS. 5A-5F depict example screenshots of a report generation portal in accordance with implementations of the present disclosure. In some examples, a user, such as the RCO, can use the data custodian portal to generate one or more reports. Continuing with the example above, and in this example, while the RCO is viewing the access management GUI 400 of FIG. 4D, the RCO can select a report generation option. In the example of FIG. 4D, a digital assistant dialog box 406 is displayed. The RCO can input a natural language description for the type of report that is to be generated. Although report generation is described herein as initiating from the access management GUI 400, it is contemplated that the report generation can be initiated from any appropriate GUI (e.g., any GUI including a selectable, digital assistant icon). For example, FIG. 5A depicts a report generation screen 500 that can be displayed in response to user selection to initiate report generation from any appropriate screen of the data custodian portal.

In the example of FIG. 5A, the report generation GUI 500 includes a create report section 502, and a report detail section 504. In some examples, the user inputs a natural language description of the report that is to be generated in the create report section (or the natural language description is carried over form another interface, such as the digital assistant dialog box 406 of FIG. 4D). The report detail section 504 provides a listing of available reports based on the natural language description.

FIGS. 5B-5F depict an example report GUI 506, which can be displayed in response to user instructions to open reports (e.g., selecting Open All in FIG. 5A). The example report GUI 506 includes a report summary section 508, and a report detail section 510. In the depicted example, the requested compliance report is selected, and is displayed in the example report GUI 506. With particular reference to FIGS. 5D and 5E, the user can insert comments into various portions of the report. For example, the user can select a portion of the report, and insert/save a comment. With particular reference to FIG. 5F, the user can share the report(s). For example, a share report dialog box 512 can be provided, through which the user can select a recipient, and provide a message.

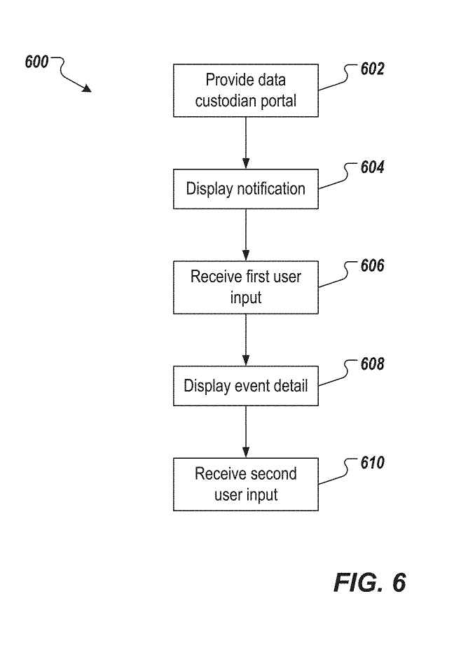

FIG. 6 depicts an example process 600 that can be executed in accordance with implementations of the present disclosure. In some examples, the example process 600 can be provided by one or more computer-executable programs executed using one or more computing devices.

A data custodian portal is provided (602). For example, the data custodian portal 202 of FIG. 2 is provided. The data custodian portal that communicates with a data custodian region within an infrastructure of a public cloud through a connector executed within the data custodian region. The data custodian region is specific to a customer of an enterprise having one or more computer-implemented services hosted on the public cloud. The infrastructure includes a plurality of regional data centers, through which customer data passes and/or is stored, each data center being at a location within a region.

A notification is displayed within a GUI of the data custodian portal (604). For example, in response to a determination that a data event associated with at least union fails to comply with a union definition of the at least one union, the notification is displayed (e.g., FIGS. 3D, 3E, and 3I-3K). In some examples, the union definition is used to control one or more of access, transfer, and storage of customer data within respective regional data centers. In some examples, the union definition is provided by a data custodian associated with the customer.

First user input is received through the data custodian portal (606). For example, and as described above, a user (e.g., cloud security analyst) can select the notification. In some examples, the first user input includes a request for detail regarding the data event. In response to the first user input, detail regarding the data event is provided (608). For example, FIGS. 3E-3I, and 3K depict display of detail regarding respective data events. Second user input including instructions for resolving the data event is received through the data custodian portal (610). The data event is resolved based on the instructions (see, e.g., FIGS. 3K-4D, and the respective description above).

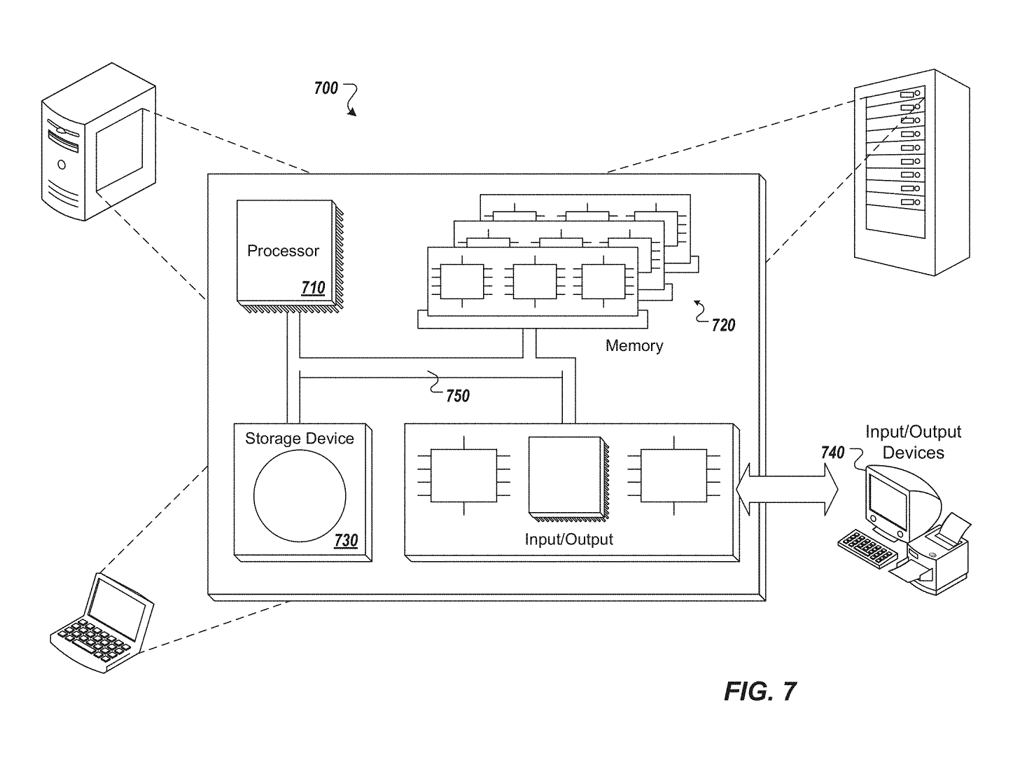

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit. The storage device 730 is capable of providing mass storage for the system 700. In one implementation, the storage device 730 is a computer-readable medium. In various different implementations, the storage device 730 may be a floppy disk device, a hard disk device, an optical disk device, or a tape device. The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for managing governance, risk, and compliance (GRC) in public clouds, the method being executed by one or more processors and comprising:
providing, by the one or more processors, a data custodian portal that communicates with a data custodian region within an infrastructure of a public cloud through a connector executed within the data custodian region, the data custodian region being specific to a customer of an enterprise having one or more computer-implemented services hosted on the public cloud, the infrastructure comprising a plurality of regional data centers, through which customer data passes and/or is stored, each data center being at a location within a region;
in response to a determination that a data event associated with at least union fails to comply with a union definition of the at least one union, displaying a notification within a graphical user interface (GUI) of the data custodian portal, the union definition being used to control one or more of access, transfer, and storage of customer data within respective regional data centers, the union definition being provided by a data custodian associated with the customer;
receiving, by the one or more processors, and through the data custodian portal, first user input comprising a request for detail regarding the data event;
in response to the first user input, providing, by the one or more processors, the detail regarding the event; and
receiving, by the one or more processors, and through the data custodian portal, second user input comprising instructions for resolving the data event.
